(19) United States
(12) Patent Application Publication
(10) Pub. No.: US 2025/0002762 A1
(43) Pub. Date: Jan. 2, 2025

(54) STELLERA CHAMAEJASME ADHESIVE MATERIAL, PREPARATION METHOD, AND USE

(71) Applicants: Southwest Minzu University, Chengdu (CN); Soochow University, Suzhou (CN)

(72) Inventors: Xianmin MAI, Chengdu (CN); Shuliang LI, Chengdu (CN); Min PAN, Chengdu (CN); Xiaoliang WANG, Chengdu (CN); Yongfa WU, Suzhou (CN); Guomin DU, Chengdu, Sichuan (CN); Tao REN, Chengdu (CN); Ting HUANG, Chengdu (CN); Dingyuan HU, Chengdu (CN)

(21) Appl. No.: 18/758,511

(22) Filed: Jun. 28, 2024

(30) Foreign Application Priority Data
Jun. 29, 2023 (CN) 202310783095.8

(51) Int. Cl. C09J 101/02; A01N 65/36

(52) U.S. Cl. CPC C09J 101/02; A01N 65/36

(57) ABSTRACT

The present disclosure discloses a stellera chamaejasme adhesive material, a preparation method, and a use. A stellera chamaejasme root is crushed, soaked with an extracting solution, evaporated for concentration, desugarized, and then further concentrated, to obtain a crude extract of the stellera chamaejasme root; and the crude extract of the stellera chamaejasme root and cellulose nanocrystals are prepared into a stable colloidal suspension, to obtain the stellera chamaejasme adhesive material. According to the embodiments of the present disclosure, a technical problem that an existing plant-based adhesive cannot be antibacterial and anticorrosive or has a complex preparation process is resolved. Alternatively, in the present disclosure, stellera chamaejasme cellulose nanocrystals are extracted from the stellera chamaejasme root, and the stellera chamaejasme cellulose nanocrystals together with the crude extract of the stellera chamaejasme root are prepared into a stable colloidal suspension.

### CROSS-REFERENCE TO RELATED APPLICATION

This application claims the benefit of Chinese Application No. 202310783095.8, filed Jun. 29, 2023, the disclosure of which is incorporated by reference herein in its entirety.

### TECHNICAL FIELD

The present disclosure relates to a stellera chamaejasme adhesive material, a preparation method, and a use.

### BACKGROUND

The adhesive industry is one of the fast-growing fine chemical industries in the world. With development of economy and enhancement of people's awareness of environmental protection, the adhesive industry receives increasing attention from countries around the world. Plant-based adhesives are biomass-based adhesives prepared by using substances such as sugars, tannins, and bean meal that are contained in plants as main components. Main sugars used in adhesive synthesis include starch, sucrose, glucose, chitosan, fructose, and the like. However, there are some shortcomings in the plant-based adhesives. For example, a starch-based adhesive and a soybean meal adhesive are limited by structures thereof, resulting in poor antibacterial performance and unsatisfactory adhesive strength. Therefore, it is required to introduce active groups such as formyl, carboxyl, amido, and isocyanate groups by adding other substances, and then the structures of the adhesives are regulated through reactions such as condensation and crosslinking, to improve antibacterial performance and adhesive strength of the adhesives.

For example, the researchers use sodium periodate to oxidize three kinds of carbohydrates (glucose, sucrose, and cassava starch) to produce non-volatile aldehydes crosslinking agents, then the non-volatile aldehydes crosslinking agents are mixed with a chitosan aqueous solution to successfully synthesize chitosan-plant-based adhesives, and the chitosan-plant-based adhesives are used to prepare plywood. In addition, adhesives with high adhesive strength may also be prepared by using soybean meal and functionalized graphene. The plant-based adhesives have a problem of a complex structural design, a complex preparation process, or poor antibacterial and anticorrosive performance.

### SUMMARY

To resolve a technical problem that an existing plant-based adhesive has a complex preparation process or cannot be antibacterial and anticorrosive, embodiments of the present disclosure provide a stellera chamaejasme adhesive material, a preparation method, and a use.

The embodiments of the present disclosure are implemented by using the following technical solutions.

According to a first aspect, an embodiment of the present disclosure provides a preparation method of a stellera chamaejasme adhesive material, including:
crushing a stellera chamaejasme root, performing soaking with an extracting solution, performing evaporation for concentration, performing desugarization, and continuing to perform concentration, to obtain a crude extract of the stellera chamaejasme root; and
preparing the crude extract of the stellera chamaejasme root and cellulose nanocrystals into a stable colloidal suspension, to obtain the stellera chamaejasme adhesive material.

Further, the crushing a stellera chamaejasme root, performing soaking with an extracting solution, performing evaporation for concentration, performing desugarization, and continuing to perform concentration, to obtain a crude extract of the stellera chamaejasme root includes:
crushing the stellera chamaejasme root, soaking stellera chamaejasme in the extracting solution at a mass ratio of stellera chamaejasme to the extracting solution of 1:10-30 for 5 days to 10 days, performing evaporation for concentration until a volume is one-tenth of a volume of the extracting solution, performing cooling and allowing to stand undisturbed for desugarization for 2 days to 4 days, and continuing to perform concentration, to obtain the crude extract of the stellera chamaejasme root.

Further, the extracting solution is ethanol or methanol.

Further, the cellulose nanocrystals include but are not limited to: stellera chamaejasme cellulose nanocrystals.

Further, preparation of the stellera chamaejasme cellulose nanocrystals includes: crushing the stellera chamaejasme root for reacting in a mixed alkali solution, to obtain a reactant; and
uniformly mixing the reactant with TEMPO, sodium hypochlorite, and sodium bromide for an oxidization reaction, and performing drying, acidolysis, and centrifugation to remove lignin, to obtain the stellera chamaejasme cellulose nanocrystals.

Further, the crushing the stellera chamaejasme root for reacting in a mixed alkali solution, to obtain a reactant includes:
crushing the stellera chamaejasme root for reacting in a mixed alkali solution of sodium hydroxide and sodium sulfite at 105° C. to 120° C. for 7 h to 10 h, to obtain the reactan;
   wherein,
a mass ratio of sodium hydroxide to sodium sulfite is 40-80:30-32.

Further, a volume of the mixed alkali solution is 600 mL to 800 mL.

Further, the uniformly mixing the reactant with TEMPO, sodium hypochlorite, and sodium bromide for an oxidization reaction, and performing drying, acidolysis, and centrifugation to remove lignin, to obtain the stellera chamaejasme cellulose nanocrystals includes:
adding TEMPO, sodium hypochlorite, and sodium bromide to the reactant for oxidation for 7 h to 12 h, performing soaking with water for 2 h to 4 h, and performing drying, to obtain an oxide; and
performing acidolysis on the oxide by using H₂SO₄ with a mass fraction of 64% at 45° C. to 50° C. for 1 h to 2 h, and after standing undisturbed, performing centrifugation and dialysis, to obtain the stellera chamaejasme cellulose nanocrystals.

Further, the preparing the crude extract of the stellera chamaejasme root and cellulose nanocrystals into a stable colloidal suspension, to obtain the stellera chamaejasme adhesive material includes:
preparing the crude extract of the stellera chamaejasme root into an ethanol dispersion of the crude extract of the stellera chamaejasme root;
preparing the cellulose nanocrystals into an ethanol dispersion of the cellulose nanocrystals; and
uniformly mixing the ethanol dispersion of the crude extract of the stellera chamaejasme root with the ethanol dispersion of the cellulose nanocrystals to obtain the stellera chamaejasme adhesive material.

Further, a mass ratio of the ethanol dispersion of the crude extract of the stellera chamaejasme root to the ethanol dispersion of the cellulose nanocrystals is 2-10:1; and a mass ratio of the crude extract of the stellera chamaejasme root in the ethanol dispersion of the crude extract of the stellera chamaejasme root to the cellulose nanocrystals in the ethanol dispersion of the cellulose nanocrystals is 2-10:1.

According to a second aspect, an embodiment of the present disclosure provides a stellera chamaejasme adhesive material, prepared by uniformly mixing a crude extract of a stellera chamaejasme root with cellulose nanocrystals, where a mass ratio of the extract of the stellera chamaejasme root to the cellulose nanocrystals is 2-10:1.

According to a third aspect, an embodiment of the present disclosure provides a use of a stellera chamaejasme adhesive material, prepared by using the preparation method of a stellera chamaejasme adhesive material, in preparing an antibacterial and anticorrosive adhesive.

Compared with the conventional technology, the embodiments of the present disclosure have the following advantages and beneficial effects:

According to the stellera chamaejasme adhesive material, the preparation method, and the use in the embodiments of the present disclosure, the stellera chamaejasme root is crushed, soaked with the extracting solution, evaporated for concentration, desugarized, and then further concentrated, to obtain the crude extract of the stellera chamaejasme root. The stellera chamaejasme root is crushed for reacting in the mixed alkali solution to obtain the reactant. The crude extract of the stellera chamaejasme root and the cellulose nanocrystals are prepared into the stable colloidal suspension, to obtain the stellera chamaejasme adhesive material. Therefore, a technical problem that an existing plant-based adhesive has a complex preparation process or cannot be antibacterial and anticorrosive is resolved.

The embodiments of the present disclosure further provide a stellera chamaejasme adhesive material. The stellera chamaejasme root is crushed for reacting in the mixed alkali solution, to obtain the reactant; the reactant is uniformly mixed with TEMPO, sodium hypochlorite, and sodium bromide for the oxidization reaction, and drying, acidolysis, and centrifugation are performed to remove lignin, to obtain the stellera chamaejasme cellulose nanocrystals; and the crude extract of the stellera chamaejasme root and the stellera chamaejasme cellulose nanocrystals are prepared into the stable colloidal suspension, to obtain the stellera chamaejasme adhesive material.

### BRIEF DESCRIPTION OF DRAWINGS

To more clearly describe the technical solutions of the exemplary implementations of the present disclosure, the accompanying drawings required in the embodiments are described briefly below. It should be understood that the following accompanying drawings illustrate only some embodiments of the present disclosure and therefore should not be construed as a limitation on the scope thereof. For a person of ordinary skill in the art, other relevant accompanying drawings can also be obtained from these accompanying drawings without any creative effort.

FIG. 1 is a result diagram of adhesive strength of a cellulose nanocrystalline film and a stellera chamaejasme adhesive material film;

FIG. 2 is a comparison diagram of antibacterial performance measurement of a cellulose nanocrystalline film (left) and a stellera chamaejasme adhesive material film (right);

FIG. 3 is an antibacterial comparison diagram of a blank medium and toxic media with different concentrations (mass fractions) based on a plate hyphal growth inhibition method, where FIG. 3a is an antibacterial schematic diagram of the blank medium, and FIG. 3b is an antibacterial schematic diagram of the toxic media with different concentrations;

FIG. 4 is a schematic diagram of a shape, a size, and an alignment manner of a sample; and

FIG. 5 is a schematic flowchart of a preparation method of a stellera chamaejasme adhesive material.

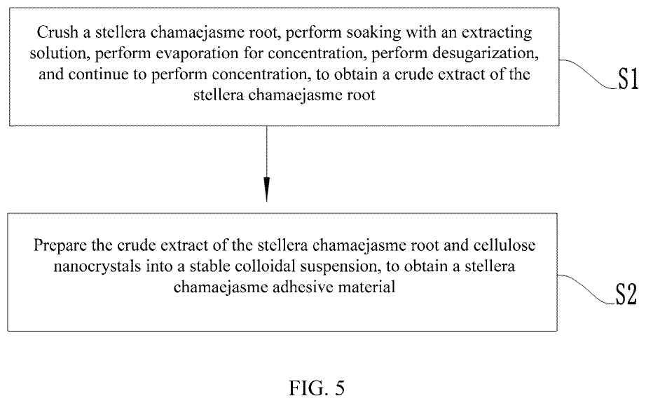

### DESCRIPTION OF EMBODIMENTS

To make the objectives, technical solutions, and advantages of the present disclosure clearer, the present disclosure is further described in detail below with reference to embodiments and the accompanying drawing. The schematic implementations of the present disclosure and descriptions thereof are only used to explain the present disclosure, but are not intended to limit the present disclosure.

In the following descriptions, a number of specific details are described to provide a thorough understanding of the present disclosure. However, it is obvious to a person of ordinary skill in the art that these specific details are not necessarily used to implement the present disclosure. In other embodiments, to avoid confusion with the present disclosure, well-known structures, circuits, materials, or methods are not specifically described.

Throughout the specification, referring to “one embodiment”, “an embodiment”, “one example”, or “an example” means that specific features, structures, or characteristics described with reference to this embodiment or example are included in at least one embodiment of the present disclosure. Therefore, the phrase “one embodiment”, “an embodiment”, “one example”, or “an example” that appears in various parts of the entire specification does not necessarily refer to the same embodiment or example. In addition, specific features, structures, or characteristics may be combined in one or more embodiments or examples in any suitable combination and/or sub-combination. In addition, a person of ordinary skill in the art should understand that all diagrams provided herein are for the purpose of description, and the diagrams are not necessarily drawn to scale. The term “and/or” used herein includes any and all combinations of one or more related listed items.

In the description of the present disclosure, the orientation or position relationships indicated by the terms “front”, “rear”, “left”, “right”, “upper”, “lower”, “vertical”, “horizontal”, “high”, “low”, “inner”, “outer”, and the like are orientation or position relationships shown in the accompanying drawings, and are only for the purpose of facilitating the description of the present disclosure and simplifying the description, but are not intended to indicate or imply that an apparatus or an element referred to needs to have a specific orientation or needs to be constructed and operated in a specific orientation. Therefore, the orientation or position relationships cannot be understood as limiting the protection scope of the present disclosure.

### EMBODIMENTS

To resolve a technical problem that an existing plant-based adhesive has a complex preparation process or cannot be antibacterial and anticorrosive, according to a first aspect, an embodiment of the present disclosure provides a preparation method of a stellera chamaejasme adhesive material, including:

S1: Crush a stellera chamaejasme root, perform soaking with an extracting solution, perform evaporation for concentration, perform desugarization, and continue to perform concentration, to obtain a crude extract of the stellera chamaejasme root.

S2: Prepare the crude extract of the stellera chamaejasme root and cellulose nanocrystals into a stable colloidal suspension, to obtain the stellera chamaejasme adhesive material.

The cellulose nanocrystals include but are not limited to: stellera chamaejasme cellulose nanocrystals.

Preparation of the stellera chamaejasme cellulose nanocrystals includes:
crushing the stellera chamaejasme root for reacting in a mixed alkali solution, to obtain a reactant; and
uniformly mixing the reactant with TEMPO, sodium hypochlorite, and sodium bromide for an oxidization reaction, and performing drying, acidolysis, and centrifugation to remove lignin, to obtain the stellera chamaejasme cellulose nanocrystals.

Therefore, in this embodiment of the present disclosure, the stellera chamaejasme root is crushed, soaked with the extracting solution, evaporated for concentration, desugarized, and then concentrated, to obtain the crude extract of the stellera chamaejasme root. The stellera chamaejasme root is crushed for reacting in the mixed alkali solution to obtain the reactant. The reactant is uniformly mixed with TEMPO, sodium hypochlorite, and sodium bromide for an oxidization reaction, and drying, acidolysis, and centrifugation are performed to remove lignin, to obtain the stellera chamaejasme cellulose nanocrystals. The crude extract of the stellera chamaejasme root and the stellera chamaejasme cellulose nanocrystals are prepared into the stable colloidal suspension, to obtain the stellera chamaejasme adhesive material. Therefore, a technical problem that an existing plant-based adhesive has a complex preparation process or cannot be antibacterial and anticorrosive is resolved.

Further, the crushing a stellera chamaejasme root, performing soaking with an extracting solution, performing evaporation for concentration, performing desugarization, and continuing to perform concentration, to obtain a crude extract of the stellera chamaejasme root includes:

crushing the stellera chamaejasme root, soaking stellera chamaejasme in the extracting solution at a mass ratio of stellera chamaejasme to the extracting solution of 1:10-30 for 5 days to 10 days, performing evaporation for concentration until a volume is one-tenth of a volume of the extracting solution, performing cooling and allowing to stand undisturbed for desugarization for 2 days to 4 days, and continuing to perform concentration, to obtain the crude extract of the stellera chamaejasme root.

Further, the extracting solution is ethanol or methanol.

Further, the crushing the stellera chamaejasme root for reacting in a mixed alkali solution, to obtain a reactant includes:
crushing the stellera chamaejasme root for reacting in a mixed alkali solution of sodium hydroxide and sodium sulfite at 105° C. to 120° C. for 7 h to 10 h, to obtain the reactant, where
a mass ratio of sodium hydroxide to sodium sulfite is 40-80:30-32.

Further, a volume of the mixed alkali solution is 600 mL to 800 mL.

Further, the uniformly mixing the reactant with TEMPO, sodium hypochlorite, and sodium bromide for an oxidization reaction, and performing drying, acidolysis, and centrifugation to remove lignin, to obtain the stellera chamaejasme cellulose nanocrystals includes:
adding TEMPO, sodium hypochlorite, and sodium bromide to the reactant for oxidation for 7 h to 12 h, performing soaking with water for 2 h to 4 h, and performing drying, to obtain an oxide; and
performing acidolysis on the oxide by using H₂SO₄ with a mass fraction of 64% at 45° C. to 50° C. for 1 h to 2 h, and after standing undisturbed, performing centrifugation and dialysis, to obtain the stellera chamaejasme cellulose nanocrystals.

Further, the preparing the crude extract of the stellera chamaejasme root and stellera chamaejasme cellulose nanocrystals into a stable colloidal suspension, to obtain the stellera chamaejasme adhesive material includes:
preparing the crude extract of the stellera chamaejasme root into an ethanol dispersion of the crude extract of the stellera chamaejasme root;
preparing the stellera chamaejasme cellulose nanocrystals into an ethanol dispersion of the stellera chamaejasme cellulose nanocrystals; and
uniformly mixing the ethanol dispersion of the crude extract of the stellera chamaejasme root with the ethanol dispersion of the cellulose nanocrystals to obtain the stellera chamaejasme adhesive material.

Further, a mass ratio of the ethanol dispersion of the crude extract of the stellera chamaejasme root to the ethanol dispersion of the cellulose nanocrystals is 2-10:1; and a mass ratio of the crude extract of the stellera chamaejasme root in the ethanol dispersion of the crude extract of the stellera chamaejasme root to the stellera chamaejasme cellulose nanocrystals in the ethanol dispersion of the cellulose nanocrystals is 2-10:1.

According to a second aspect, an embodiment of the present disclosure provides a stellera chamaejasme adhesive material, prepared by uniformly mixing a crude extract of a stellera chamaejasme root with cellulose nanocrystals, where a mass ratio of the extract of the stellera chamaejasme root to the cellulose nanocrystals is 2-10:1.

According to a third aspect, an embodiment of the present disclosure provides a use of a stellera chamaejasme adhesive material, prepared by using the preparation method of a stellera chamaejasme adhesive material, in preparing an antibacterial and anticorrosive adhesive.

### Embodiment 1

A preparation method of a stellera chamaejasme adhesive material, including:

S1: Crush a stellera chamaejasme root, soak stellera chamaejasme in an extracting solution at a mass ratio of stellera chamaejasme to ethanol of 1:10 for 5 days, perform evaporation for concentration until a volume is one-tenth of a volume of the extracting solution, perform cooling and allow to stand undisturbed for desugarization for 2 days, and continue to perform concentration, to obtain the crude extract of the stellera chamaejasme root.

S2: Crush the stellera chamaejasme root for reacting in a mixed alkali solution of sodium hydroxide and sodium sulfite at 105° C. for 7 h, to obtain a reactant, where a mass ratio of sodium hydroxide to sodium sulfite is 40:30, and a volume of the mixed alkali solution is 600 mL.

S3: Add TEMPO, sodium hypochlorite, and sodium bromide to the reactant for oxidation for 7 h, perform soaking with water for 2 h, and perform drying, to obtain an oxide; and perform acidolysis on the oxide by using H₂SO₄ with a mass fraction of 64% at 45° C. for 1 h, and after standing undisturbed, perform centrifugation and dialysis, to obtain the stellera chamaejasme cellulose nanocrystals.

S4: Prepare the crude extract of the stellera chamaejasme root into an ethanol dispersion of the crude extract of the stellera chamaejasme root;
prepare the stellera chamaejasme cellulose nanocrystals into an ethanol dispersion of the stellera chamaejasme cellulose nanocrystals; and
uniformly mix the ethanol dispersion of the crude extract of the stellera chamaejasme root with the ethanol dispersion of the stellera chamaejasme cellulose nanocrystals, to obtain the stellera chamaejasme adhesive material, where a mass ratio of the ethanol dispersion of the crude extract of the stellera chamaejasme root to the ethanol dispersion of the stellera chamaejasme cellulose nanocrystals is 1:1, and a mass ratio of the crude extract of the stellera chamaejasme root in the ethanol dispersion of the crude extract of the stellera chamaejasme root to the stellera chamaejasme cellulose nanocrystals in the ethanol dispersion of the stellera chamaejasme cellulose nanocrystals is 1:1.

### Embodiment 2

A preparation method of a stellera chamaejasme adhesive material, including:

S1: Crush a stellera chamaejasme root, soak stellera chamaejasme in an extracting solution at a mass ratio of stellera chamaejasme to ethanol of 1:30 for 10 days, perform evaporation for concentration until a volume is one-tenth of a volume of the extracting solution, perform cooling and allow to stand undisturbed for desugarization for 4 days, and continue to perform concentration, to obtain the crude extract of the stellera chamaejasme root.

S2: Crush the stellera chamaejasme root for reacting in a mixed alkali solution of sodium hydroxide and sodium sulfite at 120° C. for 10 h, to obtain a reactant, where a mass ratio of sodium hydroxide to sodium sulfite is 80:32, and a volume of the mixed alkali solution is 800 mL.

S3: Add TEMPO, sodium hypochlorite, and sodium bromide to the reactant for oxidation for 12 h, perform soaking with water for 4 h, and perform drying, to obtain an oxide; and perform acidolysis on the oxide by using H₂SO₄ with a mass fraction of 64% at 50° C. for 1 h to 2 h, and after standing undisturbed, perform centrifugation and dialysis, to obtain the stellera chamaejasme cellulose nanocrystals.

S4: Prepare the crude extract of the stellera chamaejasme root into an ethanol dispersion of the crude extract of the stellera chamaejasme root;
prepare the stellera chamaejasme cellulose nanocrystals into an ethanol dispersion of the stellera chamaejasme cellulose nanocrystals; and
uniformly mix the ethanol dispersion of the crude extract of the stellera chamaejasme root with the ethanol dispersion of the stellera chamaejasme cellulose nanocrystals, to obtain the stellera chamaejasme adhesive material, where a mass ratio of the ethanol dispersion of the crude extract of the stellera chamaejasme root to the ethanol dispersion of the stellera chamaejasme cellulose nanocrystals is 6:1, and a mass ratio of the crude extract of the stellera chamaejasme root in the ethanol dispersion of the crude extract of the stellera chamaejasme root to the stellera chamaejasme cellulose nanocrystals in the ethanol dispersion of the stellera chamaejasme cellulose nanocrystals is 6:1.

### Embodiment 3

A preparation method of a stellera chamaejasme adhesive material, including:

S1: Crush a stellera chamaejasme root, soak stellera chamaejasme in an extracting solution at a mass ratio of stellera chamaejasme to ethanol of 1:25 for 8 days, perform evaporation for concentration until a volume is one-tenth of a volume of the extracting solution, perform cooling and allow to stand undisturbed for desugarization for 3 days, and continue to perform concentration, to obtain the crude extract of the stellera chamaejasme root.

S2: Crush the stellera chamaejasme root for reacting in a mixed alkali solution of sodium hydroxide and sodium sulfite at 110° C. for 8 h, to obtain a reactant, where a mass ratio of sodium hydroxide to sodium sulfite is 70:31, and a volume of the mixed alkali solution is 700 mL.

S3: Add TEMPO, sodium hypochlorite, and sodium bromide to the reactant for oxidation for 10 h, perform soaking with water for 3 h, and perform drying, to obtain an oxide; and perform acidolysis on the oxide by using H₂SO₄ with a mass fraction of 64% at 50° C. for 1.5 h, and after standing undisturbed, perform centrifugation and dialysis, to obtain the stellera chamaejasme cellulose nanocrystals.

S4: Prepare the crude extract of the stellera chamaejasme root into an ethanol dispersion of the crude extract of the stellera chamaejasme root;
prepare the stellera chamaejasme cellulose nanocrystals into an ethanol dispersion of the stellera chamaejasme cellulose nanocrystals; and
uniformly mix the ethanol dispersion of the crude extract of the stellera chamaejasme root with the ethanol dispersion of the stellera chamaejasme cellulose nanocrystals, to obtain the stellera chamaejasme adhesive material, where a mass ratio of the ethanol dispersion of the crude extract of the stellera chamaejasme root to the ethanol dispersion of the stellera chamaejasme cellulose nanocrystals is 3:1, and a mass ratio of the crude extract of the stellera chamaejasme root in the ethanol dispersion of the crude extract of the stellera chamaejasme root to the stellera chamaejasme cellulose nanocrystals in the ethanol dispersion of the stellera chamaejasme cellulose nanocrystals is 3:1.

### Embodiment 4

A preparation method of a stellera chamaejasme adhesive material, including:

S1: Crush a stellera chamaejasme root, soak stellera chamaejasme in an extracting solution at a mass ratio of stellera chamaejasme to ethanol of 1:25 for 8 days, perform evaporation for concentration until a volume is one-tenth of a volume of the extracting solution, perform cooling and allow to stand undisturbed for desugarization for 3 days, and continue to perform concentration, to obtain the crude extract of the stellera chamaejasme root.

S2: Prepare the crude extract of the stellera chamaejasme root into an ethanol dispersion of the crude extract of the stellera chamaejasme root;
prepare purchased cellulose nanocrystals into an ethanol dispersion of the cellulose nanocrystals; and
uniformly mix the ethanol dispersion of the crude extract of the stellera chamaejasme root with the ethanol dispersion of the cellulose nanocrystals, to obtain the stellera chamaejasme adhesive material, where a mass ratio of the ethanol dispersion of the crude extract of the stellera chamaejasme root to the ethanol dispersion of the cellulose nanocrystals is 3:1, and a mass ratio of the crude extract of the stellera chamaejasme root in the ethanol dispersion of the crude extract of the stellera chamaejasme root to the cellulose nanocrystals in the ethanol dispersion of the cellulose nanocrystals is 3:1.

### Test

An ISO adhesive strength test and an antibacterial activity test are performed on the stellera chamaejasme adhesive material prepared in Embodiment 2. The antibacterial activity test mainly uses a plate hyphal growth inhibition method.

ISO 4587:2003 Adhesive strength test:

1. Tensile testing machine: It should be ensured that a fracture rate of a sample is between 10% and 80% of a full scale capacity when the tensile testing machine is selected. A response time of the machine should be short enough to accurately measure force applied during fracture. A difference between a recorded force and an actually applied force shall not exceed 1%. The machine should be capable of maintaining a constant test speed. In this case, the machine should be capable of maintaining a loading rate of 8.3 MPa/min to 9.7 MPa/min.

2. A rigid material is selected as a substrate.

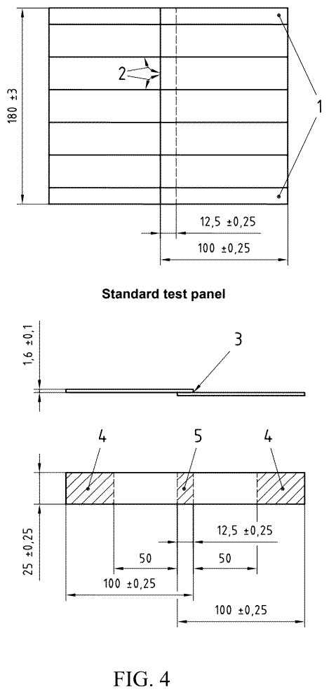

3. The sample shall conform to a shape, a size, and an alignment manner of an adhered substance shown in FIG. 4. An overlapping length should be 12.5 mm±0.25 mm. For a metal adhesive, a long axis of the sample should be the same as a rolling direction.

4. A thickness of an adhesive layer is 0.2 mm.

5. There are no less than five test samples.

6. The samples are symmetrically placed in fixtures, and a distance between each fixture and an overlapped nearest edge is 50 mm±1 mm. A gasket may be used in the fixture, so that the applied force is in an adhesive plane. The machine is operated at a constant test speed, so that an average connector is fractured within 65 s±20 s. If a machine operating at a constant loading rate is used, a shear load is applied at a rate of 8.3 MPa to 9.8 MPa per minute.

7. A test result is expressed as an arithmetic average value of fracture forces (unit: N) or fracture stresses (unit: MPa) of valid samples. Lap shear strength (unit: MPa) is calculated by dividing the fracture force (unit: N) by a shear area (unit: mm²).

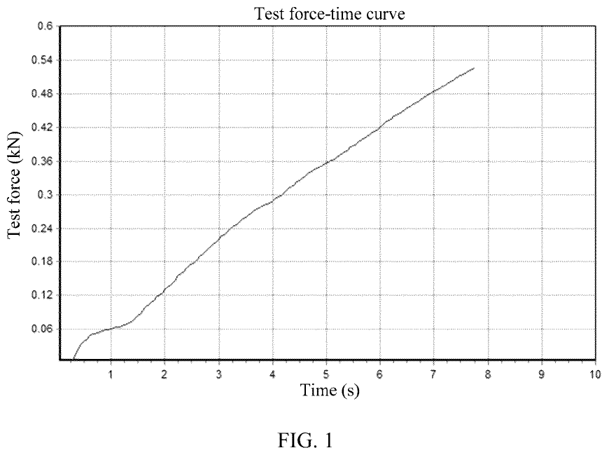

Test result: As shown in FIG. 1, a fracture force of an adhesive prepared after simple copolymerization is 524.6, and adhesive strength is 1.68 MPa.

Plate hyphal growth inhibition method: separately preparing toxic media whose concentrations are shown in Table 1, using a pure PDA medium plate as a blank control, using a hole puncher with a diameter of 5 mm to 6 mm to cut a mycelia-carrying medium column, that is, a mycelial cake, from an outer edge of a cultured colony, and inoculating a side that is of the mycelial cake and that carries mycelia to a center position of a culture dish. Each treatment is placed in a 28° C. incubator for culture. Each treatment is repeated for three times. A colony morphology is periodically (at day 5) observed and a colony diameter is measured by using a cross method. A growth inhibition rate is calculated as follows: growth inhibition rate=(blank net growth rate-treatment net growth rate)/blank net growth rate×100%.

TABLE 1

| No. | 1 | 2 | 3 | 4 | 5 | 6 | 7 | 8 |
|---|---|---|---|---|---|---|---|---|
| Concentration | 0 | 0.0375 | 0.075 | 0.1125 | 0.15 | 0.225 | 0.375 | 0.75 |
| (mass fraction)/% | | | | | | | | |

### Test Results:

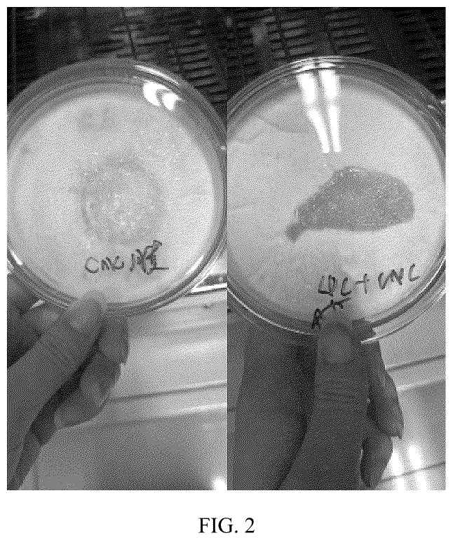

1. With reference to FIG. 2, a cellulose nanocrystalline film does not have an anticorrosive effect, but has an obvious anticorrosive effect after being mixed with the ethanol crude extract of stellera chamaejasme. The CNC film and the composite film are simultaneously cultured in the culture dishes for 7 days. The CNC film is completely degraded but the composite film is intact.

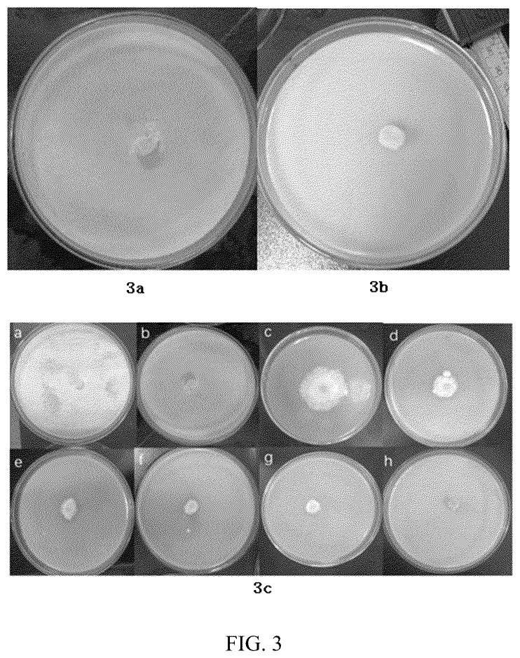

2. With reference to FIG. 3a and FIG. 3b in FIG. 3, after 10 days of culture at 28° C., white-rot fungal mycelia in a blank culture dish cover the entire culture dish, but growth of white-rot fungal mycelia in the toxic medium is inhibited, as shown in FIG. 3c.

The objectives, technical solutions, and beneficial effects of the present disclosure are further described in detail in the above specific implementations. It should be understood that the above described are only specific implementations of the present disclosure and are not intended to limit the protection scope of the present disclosure. Any modification, equivalent replacement, improvement, and the like made within the spirit and principle of the present disclosure should fall within the protection scope of the present disclosure.

What is claimed is:

1. A method of preparing a stellera chamaejasme adhesive material, comprising:
crushing a stellera chamaejasme root, performing soaking with an extracting solution, performing evaporation for concentration, performing desugarization, and continuing to perform concentration, to obtain a crude extract of the stellera chamaejasme root;
obtaining cellulose nanocrystals; and
combining the crude extract of the stellera chamaejasme root and cellulose nanocrystals into a stable colloidal suspension, to obtain the stellera chamaejasme adhesive material.

2. The method of claim 1, wherein the crushing a stellera chamaejasme root, performing soaking with an extracting solution, performing evaporation for concentration, performing desugarization, and continuing to perform concentration, to obtain a crude extract of the stellera chamaejasme root comprises:
crushing the stellera chamaejasme root, soaking stellera chamaejasme in the extracting solution at a mass ratio of stellera chamaejasme to the extracting solution of 1:10-30 for 5 days to 10 days, performing evaporation for concentration until a volume is one-tenth of a volume of the extracting solution, performing cooling and allowing to stand undisturbed for desugarization for 2 days to 4 days, and continuing to perform concentration, to obtain the crude extract of the stellera chamaejasme root.

3. The method of claim 1, wherein the cellulose nanocrystals comprise stellera chamaejasme cellulose nanocrystals.

4. The method of claim 3, wherein obtaining the stellera chamaejasme cellulose nanocrystals comprises:
crushing the stellera chamaejasme root for reacting in a mixed alkali solution, to obtain a reactant; and
uniformly mixing the reactant with TEMPO, sodium hypochlorite, and sodium bromide for an oxidization reaction, and performing drying, acidolysis, and centrifugation to remove lignin, to obtain the stellera chamaejasme cellulose nanocrystals.

5. The method of claim 4, wherein the crushing the stellera chamaejasme root for reacting in a mixed alkali solution, to obtain a reactant comprises:
crushing the stellera chamaejasme root for reacting in a mixed alkali solution of sodium hydroxide and sodium sulfite at 105° C. to 120° C. for 7 h to 10 h, to obtain the reactant, wherein
a mass ratio of sodium hydroxide to sodium sulfite is 40-80:30-32.

6. The method of claim 4, wherein the uniformly mixing the reactant with TEMPO, sodium hypochlorite, and sodium bromide for an oxidization reaction, and performing drying, acidolysis, and centrifugation to remove lignin, to obtain the stellera chamaejasme cellulose nanocrystals comprises:
adding TEMPO, sodium hypochlorite, and sodium bromide to the reactant for oxidation for 7 h to 12 h, performing soaking with water for 2 h to 4 h, and performing drying, to obtain an oxide; and
performing acidolysis on the oxide by using H₂SO₄ with a mass fraction of 64% at 45° C. to 50° C. for 1 h to 2 h, and after standing undisturbed, performing centrifugation and dialysis, to obtain the stellera chamaejasme cellulose nanocrystals.

7. The method of claim 4, wherein the preparing the crude extract of the stellera chamaejasme root and cellulose nanocrystals into a stable colloidal suspension, to obtain the stellera chamaejasme adhesive material comprises:
preparing the crude extract of the stellera chamaejasme root into an ethanol dispersion of the crude extract of the stellera chamaejasme root;
preparing the cellulose nanocrystals into an ethanol dispersion of the cellulose nanocrystals; and
uniformly mixing the ethanol dispersion of the crude extract of the stellera chamaejasme root with the ethanol dispersion of the cellulose nanocrystals to obtain the stellera chamaejasme adhesive material.

8. The method of claim 7, wherein a mass ratio of the ethanol dispersion of the crude extract of the stellera chamaejasme root to the ethanol dispersion of the cellulose nanocrystals is 2-10:1.

9. A stellera chamaejasme adhesive material, prepared by uniformly mixing a crude extract of a stellera chamaejasme root with cellulose nanocrystals, wherein a mass ratio of the crude extract of the stellera chamaejasme root to the cellulose nanocrystals is 2-10:1.

10. A use of a stellera chamaejasme adhesive material, prepared by using the method of claim 1, in preparing an antibacterial and anticorrosive adhesive.

11. The method of claim 2, wherein the extracting solution is ethanol or methanol.

12. The method of claim 5, wherein a volume of the mixed alkali solution is 600 mL to 800 mL.

13. A use of a stellera chamaejasme adhesive material, prepared by using the method of claim 2, in preparing an antibacterial and anticorrosive adhesive.

14. A use of a stellera chamaejasme adhesive material, prepared by using the method of claim 3, in preparing an antibacterial and anticorrosive adhesive.

15. A use of a stellera chamaejasme adhesive material, prepared by using the method of claim 4, in preparing an antibacterial and anticorrosive adhesive.

16. A use of a stellera chamaejasme adhesive material, prepared by using the method of claim 5, in preparing an antibacterial and anticorrosive adhesive.

17. A use of a stellera chamaejasme adhesive material, prepared by using the method of claim 6, in preparing an antibacterial and anticorrosive adhesive.

18. A use of a stellera chamaejasme adhesive material, prepared by using the method of claim 7, in preparing an antibacterial and anticorrosive adhesive.

19. A use of a stellera chamaejasme adhesive material, prepared by using the method of claim 8, in preparing an antibacterial and anticorrosive adhesive.

20. A use of a stellera chamaejasme adhesive material, prepared by using the method of claim 11, in preparing an antibacterial and anticorrosive adhesive.
